(19) United States
(12) Patent Application Publication
(10) Pub. No.: US 2026/0128393 A1
(43) Pub. Date: May 7, 2026

(54) BATTERY BALANCING APPARATUS AND METHOD FOR THE SAME

(71) Applicant: HYUNDAI MOBIS CO., LTD., Seoul (KR)

(72) Inventors: Mi Ri PARK, Yongin-si (KR); Yeong Geun YEO, Yongin-si (KR)

(73) Assignee: HYUNDAI MOBIS CO., LTD., Seoul (KR)

(21) Appl. No.: 19/276,249

(22) Filed: Jul. 22, 2025

(30) Foreign Application Priority Data
Nov. 4, 2024 (KR) 10-2024-0154341

(51) Int. Cl. H01M 10/42; H01M 10/48; H02J 7/00

(52) U.S. Cl. CPC H01M 10/425; H01M 10/482; H02J 7/52; H01M 2010/4271; H01M 2010/4278; H02J 7/61

(57) ABSTRACT

A battery balancing apparatus and a method therefor are provided. The battery balancing apparatus includes a battery including battery cells, and a processor to set the battery cells to channels including a first channel and a second channel, and perform a balancing operation for the battery cells included in the second channel while sensing voltages of the battery cells included in the first channel.

### CROSS-REFERENCE TO RELATED APPLICATION

This application claims the benefit under 35 U.S.C. § 119(a) of priority to Korean Patent Application No. 10-2024-0154341 filed on Nov. 4, 2024, in the Korean Intellectual Property Office, the entire disclosure of which is incorporated herein by reference for all purposes.

### BACKGROUND

### 1. Field

Exemplary embodiments of the present disclosure relate to a battery balancing apparatus that controls balancing operation of a battery cell and method thereof.

### 2. Description of the Related Art

As electric vehicle-related technologies are developed, the required battery voltage is increasing, and thus the number of battery packs is also increasing. Accordingly, the importance of battery balancing technologies for preventing overcharging and adjusting deviations between cells is gradually increasing.

Balancing of battery cells is to reduce difference between battery cells while preventing overcharging of the battery cells. In the balancing operation, when the balancing operation is not performed for sufficient time, balancing between battery cells may not be completed, so the battery is repeatedly charged and discharged without resolving the voltage difference.

When such a state persists, thermal runaway may occur in the battery. When a thermal runaway phenomenon occurs, not only a fire may occur in the electric vehicle, but also the life of a driver may be threatened.

The balancing operation is sequentially performed based on the sensed voltage after first performing a sensing operation for sensing a voltage of the battery cell. In this case, because balancing of the battery cells takes a predetermined time, the cell balancing may not be completed until the start is turned off. Accordingly, the balancing operation may be continuously performed even when the electric vehicle is in a parking state.

For example, when sensing N channels, a total of N×1 channel conversion time is taken, during which balancing is not performed. In addition, balancing is not performed even when diagnosing the battery cell. For this reason, the battery may not have enough time to complete the balancing.

When the sufficient balancing time is not ensured, the battery may continue to be overcharged, a deviation between cells may increase, and a life of the battery cell may be shortened.

The background technology of the present disclosure is disclosed in Korean Patent Registration No. 10-2667738 (entitled “BALANCING METHOD AND APPARATUS OF BATTERY”).

### SUMMARY

Various embodiments are directed to a battery balancing apparatus and method for simultaneously performing voltage sensing and balancing of battery cells to secure balancing time.

In a general aspect, a battery balancing apparatus, includes: a battery including a plurality of battery cells; and a processor configured to set the plurality of battery cells to a plurality of channels including a first channel and a second channel, and perform a balancing operation for the battery cells included in the second channel while sensing voltages of the battery cells included in the first channel.

The processor may be further configured to set a battery cell with a voltage difference equal to or greater than a certain value from an adjacent battery cell as a balancing target among the battery cells included in the second channel based on a pre-measured voltage, and perform a balancing operation on the balancing target.

The plurality of channels may further include a third channel, wherein, in response to the voltage sensing for the first channel and the balancing operation for the second channel being completed, the processor may be further configured to set the third channel, and control voltage sensing for the battery cells included in the third channel.

The processor may further be configured to set a battery cell located at a boundary point between the first channel and the second channel to the third channel.

The processor may be further configured to control the balancing operation to not be performed in another channel while voltage sensing for the third channel is performed.

The plurality of channels may further include a fourth channel and a fifth channel, wherein, in response to the voltage sensing for the third channel being completed, the processor may be further configured to set the fourth channel and the fifth channel by adding the battery cells included in the third channel to the first and second channels or by excluding the battery cells included in the third channel from the first and second channels, perform a balancing operation on the battery cells included in the fourth channel, and sense the voltages of the battery cells included in the fifth channel.

In another general aspect, a processor-implemented method of balancing a battery, includes: setting, by a processor, a plurality of battery cells included in a battery to a plurality of channels including a first channel and a second channel; requesting, by the processor, a voltage sensing operation for the battery cells included in the first channel; and performing, by the processor, a balancing operation for the battery cells included in the second channel while the voltage sensing operation for the first channel is performed.

In the performing of the balancing operation, the processor may be configured to set a battery cell with a voltage difference equal to or greater than a certain value from an adjacent battery cell as a balancing target among the battery cells included in the second channel, based on a pre-measured voltage, and perform a balancing operation on the balancing target.

The plurality of channels may further include a third channel, the third channel including a battery cell located at a boundary point between the first channel and the second channel among the plurality of battery cells, wherein, in response to the voltage sensing for the first channel and the balancing operation for the second channel being completed, the method may further include controlling, by the processor, voltage sensing for the battery cells included in the third channel, and controlling, by the processor, the balancing operation to not be performed in another channel while the voltage sensing for the third channel is performed.

The plurality of channels may further include a fourth channel and a fifth channel, wherein the method further comprises setting, by the processor, the fourth channel and the fifth channel by adding the battery cells included in the third channel to the first channel and the second channel or by excluding the battery cells included in the third channel from the first channel and the second channel in response to the voltage sensing for the third channel is completed, performing, by the processor, a balancing operation on the battery cells included in the fourth channel, and controlling, by the processor, to sense voltages of the battery cells included in the fifth channel during the balancing operation for the fourth channel is performed.

According to an aspect, in the battery balancing apparatus and method of the present disclosure, the battery cell is divided into a plurality of channels and voltage sensing and a balancing operation are simultaneously performed for each channel to reduce the time required and ensure the time required for balancing, thereby completing the balancing of the battery cells.

According to the battery balancing apparatus and method according to an aspect, overcharging of the battery cells can be prevented and a voltage deviation between the battery cells can be reduced by balancing the battery cells.

According to the battery balancing apparatus and method according to an aspect, the efficiency of the battery can be improved and the battery life can be extended.

### BRIEF DESCRIPTION OF THE DRAWINGS

FIG. 1 is a block diagram illustrating a control configuration of a battery balancing apparatus according to an embodiment of the present disclosure.

FIGS. 2A to 2C illustrate exemplary diagrams for reference in explaining battery balancing according to an embodiment of the present disclosure.

FIG. 3 is a flow chart illustrating a balancing method of a battery balancing apparatus according to an embodiment of the present disclosure.

FIG. 4 is a flow chart illustrating a simultaneous balancing method of a battery balancing apparatus according to an embodiment of the present disclosure.

FIG. 5 is a timing diagram during sensing and balancing operation of a battery balancing apparatus according to an embodiment of the present disclosure.

FIG. 6 is an exemplary diagram illustrating a sensing and balancing operation in a first period of a battery balancing apparatus according to an embodiment of the present disclosure.

FIG. 7 is an exemplary diagram illustrating a sensing and balancing operation in a second period of a battery balancing apparatus according to an embodiment of the present disclosure.

FIG. 8 is an exemplary diagram illustrating a sensing and balancing operation in a third period of a battery balancing apparatus according to an embodiment of the present disclosure.

FIG. 9 is a diagram illustrating a diagnostic sequence of a battery balancing apparatus according to an embodiment of the present disclosure.

### DETAILED DESCRIPTION

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, embodiments that include other components in addition to the components described in the various embodiments are also included in the scope of the present disclosure.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, when a component is referred to as being “linked,” “coupled,” or “connected” to another component, it is understood that not only a direct connection relationship but also an indirect connection relationship through an intermediate component may also be included. In addition, when a component is referred to as “comprising” or “having” another component, it may mean further inclusion of another component not the exclusion thereof, unless explicitly described to the contrary.

In the present disclosure, the terms first, second, etc. are used only for the purpose of distinguishing one component from another, and do not limit the order or importance of components, etc., unless specifically stated otherwise. Thus, within the scope of this disclosure, a first component in one exemplary embodiment may be referred to as a second component in another embodiment, and similarly a second component in one exemplary embodiment may be referred to as a first component.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, exemplary embodiments that include other components in addition to the components described in the various embodiments are also included in the scope of the present disclosure.

Hereinafter, a battery balancing apparatus and a method for controlling a balancing operation of a battery cell according to the present disclosure is described in detail below with reference to the accompanying drawings through various exemplary embodiments.

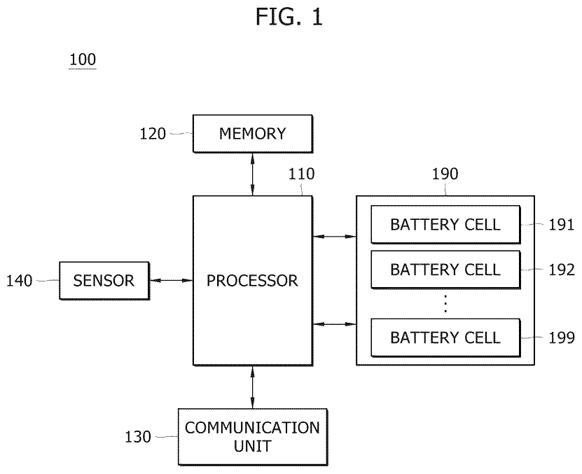

FIG. 1 is a block diagram illustrating a control configuration of a battery balancing apparatus 100 according to an embodiment of the present disclosure.

Referring to FIG. 1, the battery balancing apparatus 100 includes a memory device 120, a communication unit 130 (e.g., a communication device such as a transceiver), a sensor 140, a battery 190, and a processor 110.

The memory apparatus 120 stores data on a vehicle, data on a battery, state of charge (SOC) data of the battery, and data of a sensor. The memory device 120 stores data on temperature, current, and voltage of the battery cell measured using the sensor 140. In addition, the memory device 120 stores data on a channel temporarily set during balancing for the battery cell.

The memory device 120 may include a non-volatile memory device such as a random access memory (RAM) device, a read only memory (ROM) device, and an electrically erased programmable ROM (EEPROM) device, and storage means such as a flash memory device.

The communication unit 130 transmits and receives data between the memory device 120, the sensor 140, the battery 190, and the processor 110. In addition, the communication unit 130 transmits data within the vehicle. The communication unit 130 receives signals from an electronic control unit (ECU, not shown) of the vehicle, applies the signals to the processor 110, and transmits data according to a control command of the processor 110.

For example, the communication unit 130 transmits and receives data through either CAN communication or LIN communication within the vehicle. In addition, the communication unit 130 communicates through short-range communication such as WiFi or Bluetooth, mobile communication, wireless access in vehicular environment (WAVE) for communication between vehicles and road facilities, and vehicle to everything (V2X) for communication between vehicles.

The sensor 140 senses the charge current supplied to the battery 190 and the discharge current output from the battery 190. The sensor 140 senses at least one of temperature, current, and voltage of a plurality of battery cells provided in the battery 190. For example, the sensor 140 may include a temperature sensor, a current sensor, and a voltage sensor.

The battery 190 is charged by the supplied charge current and supplies the discharge current to the vehicle to drive the vehicle's power source. The battery 190 includes a plurality of battery cells 191 to 199.

The processor 110 includes at least one microprocessor. The processor 110 operates based on data stored in memory and algorithm data. For example, the processor 110 may be a battery management system (BMS). Additionally, the processor 110 may be one of an electric control unit (ECU), a vehicle control unit (VCU), and a main control unit (MCU).

The processor 110 determines the state of the battery 190 in response to the temperature, current, and voltage of the battery 190, sensed by the sensor 140, and controls the battery 190. The processor 110 calculates the state of charge (SOC) of the battery 190 based on the voltage of the plurality of battery cells 191 to 199.

The processor 110 provides a charge current applied from a charger (not shown) to the battery 190 to charge the battery, and controls a discharge current output from the battery 190 to be applied to the vehicle. In addition, the processor 110 controls a relay (not shown) based on the state of the battery 190 to block the charge current or the discharge current.

The processor 110 calculates the voltage difference between the plurality of battery cells based on the voltage of the battery cells 191 to 199 included in the battery 190 measured from the sensor 140, and performs balancing according to the magnitude of the voltage difference.

The processor 110 performs voltage sensing and a balancing operation on the plurality of battery cells 191 to 199 simultaneously. The processor 110 sets simultaneous balancing mode, sets the plurality of battery cells 191 to 199 into a plurality of channels, and controls operations for each channel.

The processor 110 senses voltages for the battery cells included in a first channel among the plurality of channels and controls a balancing operation for the battery cells included in a second channel to be performed. The processor 110 may perform the balancing operation for the battery cells included in the second channel based on the voltage sensed in advance.

When the operations for the first channel and the second channel are completed, the processor 110 resets the channels. The processor 110 sets at least one battery cell located at a boundary point between the first channel and the second channel to a third channel and performs voltage sensing for the third channel. The processor 110 controls the balancing operation not to be performed on other channels while voltage sensing is performed on the third channel.

Because the battery cells included in the third channel are located adjacent to the battery cells of other channels and may be affected by the voltage of other battery cells while sensing voltage, the processor 110 may limit the balancing operation for other channels.

When voltage sensing for the third channel is completed, the processor 110 performs a balancing operation for the first channel and performs voltage detection for the second channel in an alternating manner.

Meanwhile, when voltage sensing for the third channel is completed, the processor 110 resets the channels for the plurality of battery cells 191 to 199. The processor 110 sets a fourth channel and a fifth channel by adding the battery cells included in the third channel to the first channel and the second channel or excluding the battery cells included in the third channel from the first channel and the second channel.

Accordingly, the processor 110 may perform voltage sensing for the fifth channel while performing the balancing operation for the fourth channel. For example, the fourth channel may be set as a channel in which a part of the battery cells of the third channel is added to the first channel, and the fifth channel may be set as a channel in which a part of the battery cells of the third channel is excluded from the second channel.

The processor 110 sets the plurality of battery cells 191 to 199 to a plurality of channels, performs voltage sensing or a balancing operation in units of channels, and includes or excludes a battery cell located at a boundary point of the channel in or from a specific channel.

Accordingly, the battery balancing apparatus 100 according to an aspect of the present disclosure simultaneously performs voltage sensing and a balancing operation for a plurality of battery cells, thereby shortening the time required for balancing the battery cells. The battery balancing apparatus 100 of the present disclosure can eliminate voltage difference between the battery cells, prevent a thermal runaway, and extend the life of battery by sufficiently securing balancing time.

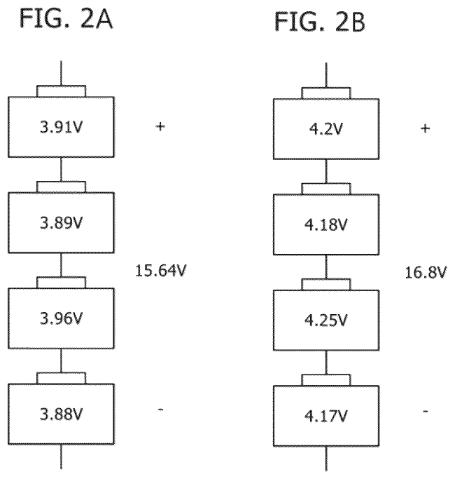

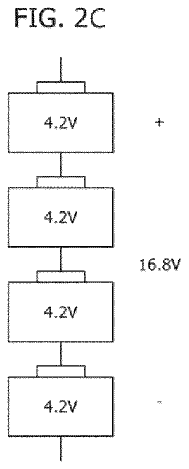

FIGS. 2A to 2C are exemplary diagrams for reference in explaining the battery balancing according to an embodiment of the present disclosure.

Referring to FIGS. 2A to 2C together with FIG. 1, the battery balancing apparatus according to the present disclosure includes a battery management system (BMS) to reduce voltage deviations between a plurality of battery cells included in the battery.

When there is sufficient time to complete the balancing operation until the start-up is terminated, the processor 110 performs a balancing operation for the plurality of battery cells 191 to 199 by setting in a general balancing mode. Meanwhile, when the time is insufficient to operate in the general balancing mode, the processor 110 may simultaneously perform voltage sensing and a balancing operation for each channel by setting a simultaneous balancing mode.

Referring to FIG. 2A, the processor 110 includes a battery management system (BMS), and when the voltages of the first to fourth battery cells are 3.91 V, 3.89 V, 3.96 V, and 3.88 V, respectively, before charging the battery, the processor 110 determines that the battery is in a state requiring charging as a total of 15.64 V.

Referring to FIG. 2B, when the voltages of the first to fourth battery cells are 4.2 V, 4.18 V, 4.25 V, and 4.17 V, respectively, after the battery 190 is charged, the processor 110 determines that some battery cells are in an overcharged state. For example, the processor 110 may determine that the third battery cell is in an overcharged state.

In the case of active balancing, the processor 110 may set in a general balancing mode to eliminate the overcharged state of the third battery cell, and perform the balancing. The processor 110 may discharge the battery cell in the overcharged state and charge the battery cell of a low voltage based on the voltage difference between the battery cells.

Meanwhile, in the case of passive balancing, the processor 110 may control the voltages of the plurality of battery cells by blocking the charge current of the third battery cell or changing the current flow to discharge the third battery cell and maintaining the supply of the charge current to the battery cell which is not completely charged.

Referring to FIG. 2C, after the balancing for the battery is completed, the voltages of the first to fourth battery cells are 4.2V, which has the same value. In this case, the voltage of the battery is 16.8V in total, which is the same as the total 16.8 V before balancing in FIG. 2B.

As described above, when a voltage difference of a predetermined magnitude or more occurs between the battery cells, or at least one battery cell is in an overcharged state, the processor 110 may perform a balancing operation on the battery cells.

Meanwhile, in the simultaneous balancing mode, the processor 110 simultaneously performs voltage sensing and a balancing operation in units of channels. In this case, the processor 110 divides the battery cells 191 to 199 into multiple channels and performs voltage sensing and a balancing operation in units of channels, rather than performing a balancing operation after sensing the entire voltage for the plurality of battery cells 191 to 199. Accordingly, there may occur a voltage difference between the battery cells located at the boundary point of the channels, and thus the processor 110 senses a voltage by setting the battery cells located at the boundary point to a separate channel.

The processor 110 may perform a balancing operation for the battery cells in a passive balancing method in the simultaneous balancing mode.

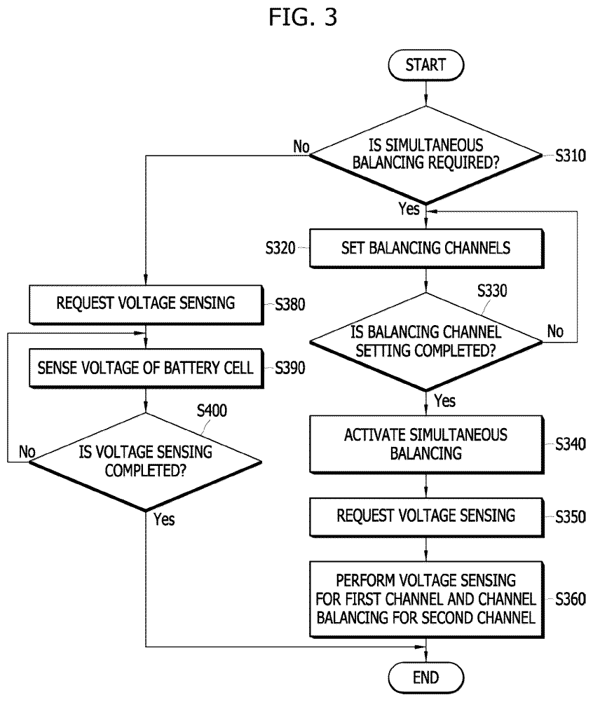

FIG. 3 is a flow chart illustrating a balancing method of a battery balancing apparatus according to an embodiment of the present disclosure.

As shown in FIG. 3 together with FIG. 1, the processor 110 determines whether simultaneous balancing is required S310 before balancing the battery cells.

When there is sufficient time to perform a balancing operation until the start-up is terminated, the processor 110 may set a general balancing mode to perform balancing for the plurality of battery cells 191 to 199, and set a simultaneous balancing mode when the time is insufficient.

In the simultaneous balancing mode, the processor 110 sets channels for the plurality of battery cells 191 to 199 (S320). The processor 110 sets the plurality of battery cells 191 to 199 to a plurality of channels. For example, the processor 110 may set the first to fifth battery cells to a lower channel which is a first channel, and set the sixth to tenth battery cells to an upper channel which is a second channel.

When the channels for the plurality of battery cells are set (S330), the processor 110 activates the simultaneous balancing (S340), and simultaneously performs voltage sensing and a balancing operation for the plurality of battery cells 191 to 199. The processor 110 sets the first channel among the plurality of channels as a sensing channel and the second channel as a balancing channel.

The processor 110 sets a battery cell to be balanced based on the voltage of the battery cell sensed in advance with respect to the battery cell before voltage sensing is performed.

The processor 110 requests the sensor 140 to sense a voltage with respect to a first channel, which is a sensing channel, among the plurality of channels set in the plurality of battery cells 191 to 199 (S350). Accordingly, the sensor 140 sequentially senses the voltages for the battery cells included in the first channel. In this case, the sensed voltages of the battery cells are stored in the memory device 120.

The processor 110 performs a balancing operation for the battery cells included in the second channel, which is the balancing channel, while the sensor 140 senses the voltages of the battery cells of the first channel (S360). The processor 110 performs balancing for the battery cells included in the second channel, which is set to be balanced. When there is a record of voltage sensing or balancing on the battery cells, the processor 110 performs balancing between the battery cells having a large voltage difference based on the stored data.

As described, the processor 110 divides the battery cells into a plurality of channels rather than performing a balancing operation after voltage sensing is completed for the plurality of battery cells 191 to 199. Accordingly, the processor 110 may perform voltage sensing on the battery cells included in one channel while performing the balancing operation on the battery cells of another channel.

Meanwhile, in a general balancing mode, the processor 110 requests the sensor 140 to sense a voltage for the plurality of battery cells 191 to 199 (S380).

The sensor 140 senses voltages of the plurality of battery cells 191 to 199 (S390).

When voltage sensing for the plurality of battery cells 191 to 199 is completed by the sensor 140 in the general balancing mode (S400), the processor 110 performs a balancing operation on the battery cells with a large voltage difference among the plurality of battery cells, based on the sensed voltage.

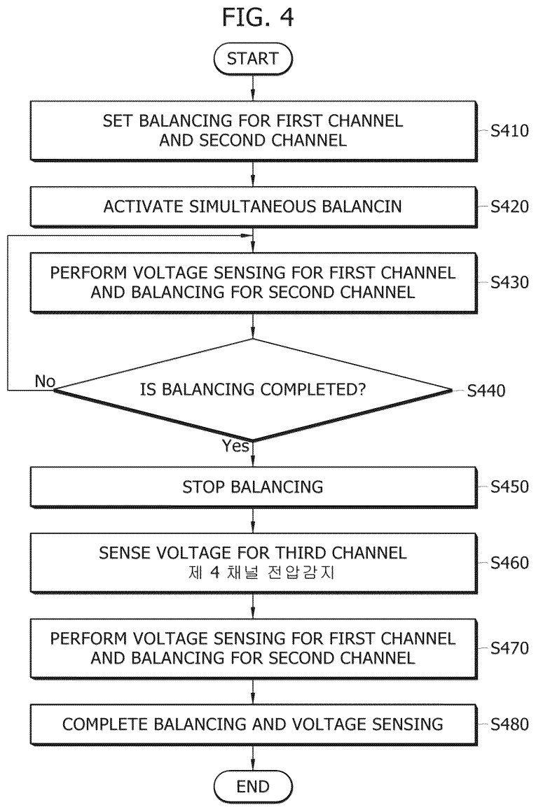

FIG. 4 is a flow chart illustrating a simultaneous balancing method of a battery balancing apparatus according to an embodiment of the present disclosure.

Referring to FIG. 4 together with FIG. 1, when the simultaneous balancing mode is set, the processor 110 sets the channels for a plurality of battery cells 191 to 199 (S410). For example, the processor 110 may set the first channel and the second channel in units of five battery cells for ten battery cells. The first to fifth battery cells may be set to the first channel, and the sixth to tenth battery cells may be set to the second channel.

The processor 110 activates the simultaneous balancing (S420), and requests the sensor 140 to sense voltages. For example, the processor 110 may request the sensor 140 to sense the voltages of the battery cells of the first channel that is a sensing channel. The sensor 140 senses the voltages of the battery cells included in the first channel in response to a control command of the processor 110.

While voltage sensing for the battery cells of the first channel is performed, the processor 110 performs a balancing operation on preset balancing targets among the battery cells of the second channel that is a balancing channel (S430). When a voltage difference between adjacent battery cells among the plurality of battery cells included in the second channel is greater than or equal to a preset value, the processor 110 sets the battery cells as the balancing targets.

When balancing for the second channel is completed (S440), the processor 110 stops balancing (S450).

When voltage sensing for the first channel is completed, the processor 110 resets the battery cell located at a boundary point between the first channel and the second channel among the plurality of battery cells to a separate third channel. The third channel may be set as a sensing channel. Here, the boundary point indicates a point for distinguishing the first channel from the second channel in the first channel composed of the first to fifth battery cells and the second channel composed of the sixth to tenth battery cells. For example, the processor 110 may set the fifth and sixth battery cells adjacent to the boundary point to the third channel.

The processor 110 controls the sensor 140 to sense a voltage for the third channel (S460). Because the voltage sensing and balancing of the battery cells are performed in units of channels, the processor 110 may not identify the voltage difference between the fifth battery cell of the first channel and the sixth battery cell of the second channel, and thus may sense the voltage by setting the fifth battery cell and the sixth battery cell to the third channel.

When voltage sensing for the third channel is completed, the processor 110 resets a fourth channel and a fifth channel by adding the battery cells included in the third channel to the first channel and the second channel, respectively, or excluding the battery cells included in the third channel from the first channel and the second channel, respectively.

For example, the processor 110 may set the fourth channel by excluding a fifth battery cell from the first channel, and set the fifth channel by adding the fifth battery cell from the second channel. In addition, the processor 110 may set the fourth channel by adding a sixth battery cell to the first channel, and set the fifth channel excluding the sixth battery cell from the second channel. On the other hand, when the number of the battery cells is odd, the processor 110 may set the fourth channel and the fifth channel by adding the battery cell at a middle point to the first channel or the second channel.

For the reset fourth channel and the fifth channel, the processor 110 sets the fourth channel as a balancing channel and sets the fifth channel as a sensing channel. The processor 110 performs balancing on the battery cells included in the fourth channel that is the balancing channel, and performs voltage sensing on the battery cells included in the fifth channel that is the sensing channel (S470).

The processor 110 simultaneously completes voltage sensing and balancing for the plurality of battery cells 191 to 199 through the simultaneous balancing mode (S480). In the simultaneous balancing mode, the processor 110 divides the plurality of battery cells 191 to 199 into a plurality of channels and cross-sets the sensing channel and the balancing channel while resetting the channels, thereby performing voltage sensing and a balancing operation simultaneously.

Therefore, the processor 110 can complete the balancing during the time for sensing voltages for the plurality of battery cells 191 to 199 and shortens the time required.

The processor 110 stores the measured voltages in the memory device 120 and sets a balancing target using the stored voltages when performing the next balancing operation.

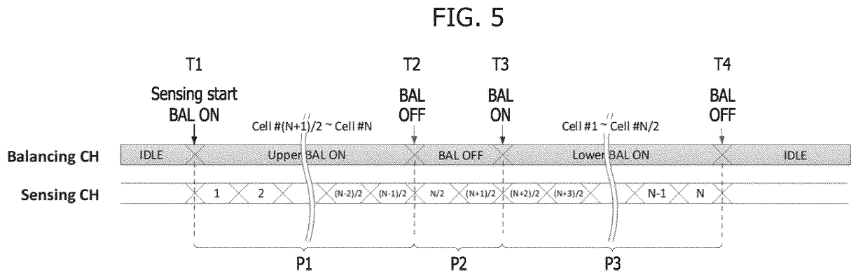

FIG. 5 is a timing diagram during sensing and balancing operations of a battery balancing apparatus according to an embodiment of the present disclosure.

As shown in FIG. 5 together with FIG. 1, the processor 110 sets the channels for the plurality of battery cells 191 to 199. For example, the processor 110 may set the first channel as a sensing channel and the second channel as a balancing channel.

For example, the processor 110 may set first to ((N−1)/2)^{th} battery cells to the first channel, and set ((N+1)/2)^{th} to N^{th} battery cells to the second channel.

When channel setting is completed, the processor 110 activates simultaneous balancing. The processor 110 controls the sensor 140 to start voltage sensing for the first channel that is the sensing channel at a first time T1, and performs a balancing operation for the second channel (BALON).

In a first period P1, the sensor 140 sequentially measures the voltages of the battery cells included in the first channel, and the processor 110 controls charging and discharging between the battery cells included in the second channel so that the voltage between adjacent battery cells becomes uniform.

When the balancing for the second channel is completed, the processor 110 ends the balancing operation at a second time T2 (BAL OFF).

When voltage sensing for the first channel is completed, the processor 110 sets the battery cell located at the boundary point between the first channel and the second channel to the third channel, and performs voltage sensing for the battery cells included in the third channel during a second period P2. For example, the processor 110 may set the (N/2)^{th} battery cell and the ((N+1)/2)^{th} battery cell to the third channel. The sensor 140 senses the voltage for the battery cells of the third channel in response to a control command of the processor 110 in the second period P2.

When voltage sensing of the third channel is completed at a third time T3, the processor 110 performs voltage sensing and balancing on the first channel and the second channel in an alternating manner during a third period P3. The processor 110 performs balancing on the first channel and controls the sensor 140 to sense a voltage for the second channel.

When the balancing for the first channel is completed, the processor 110 ends the balancing at a fourth time T4 (BAL OFF).

Meanwhile, the processor 110 sets the fourth channel and the fifth channel by changing the channel for the battery cells included in the third channel according to whether balancing for the battery cells of the third channel is performed. For example, the processor 110 may set the fourth channel by adding a sixth battery cell to the first channel, and set the fifth channel by excluding the sixth battery cell from the second channel. In addition, the processor 110 may set the fourth channel by excluding the fifth battery cell from the first channel, and set the fifth channel by adding the fifth battery cell to the second channel.

For example, the processor 110 may set the first to (N/2)^{th} battery cells to the fourth channel, and set the ((N+2)/2)^{th} to N^{th} battery cells to the fifth channel.

The processor 110 may be configured to perform balancing on the fourth channel and voltage sensing on the fifth channel.

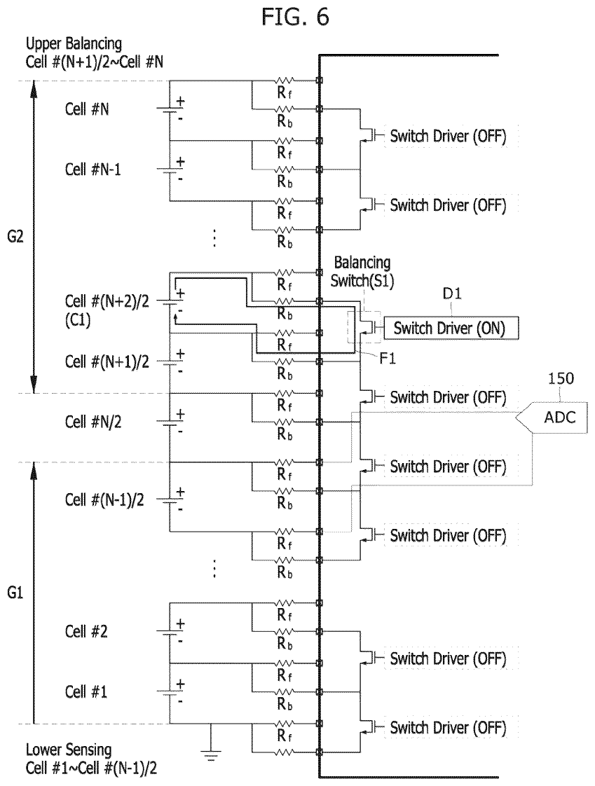

FIG. 6 is an exemplary diagram illustrating sensing and balancing operations in a first period of a battery balancing apparatus according to an embodiment of the present disclosure.

As shown in FIG. 6, in a first period P1, the processor 110 enables voltage sensing of the battery cells of a first channel G1 using an analog-to-digital converter (ADC) 150. In addition, the processor 110 performs balancing of the battery cells for a second channel G2.

For example, the processor 110 may set the first battery cell to the ((N−1)/2)^{th} battery cell to the first channel G1 and set the ((N+1)/2)^{th} battery cell to the N^{th} battery cell to the second channel G2.

When the voltage is measured for each battery cell in the sensing channel, the processor 110 converts the measured voltage using one ADC 150 and receives the converted voltage. The sensor 140 may include the ADC 150.

The processor 110 senses a voltage by sequentially connecting the first battery cell to the ((N−1)/2)^{th} battery cell of the first channel that is the sensing channel to the ADC 150. The processor 110 performs balancing on a preset balancing target C1 among the ((N+1)/2)^{th} battery cell to the N^{th} battery cell included in the second channel.

The processor 110 performs the balancing operation by turning on a switch driver D1 connected to a first balancing target C1 to control a first balancing switch S1 connected to the first balancing target C1.

The processor 110 controls the current flowing along a first balancing path F1 by applying a control signal to the switch driver D1 to operate the first balancing switch S1, thereby charging or discharging the first balancing target C1.

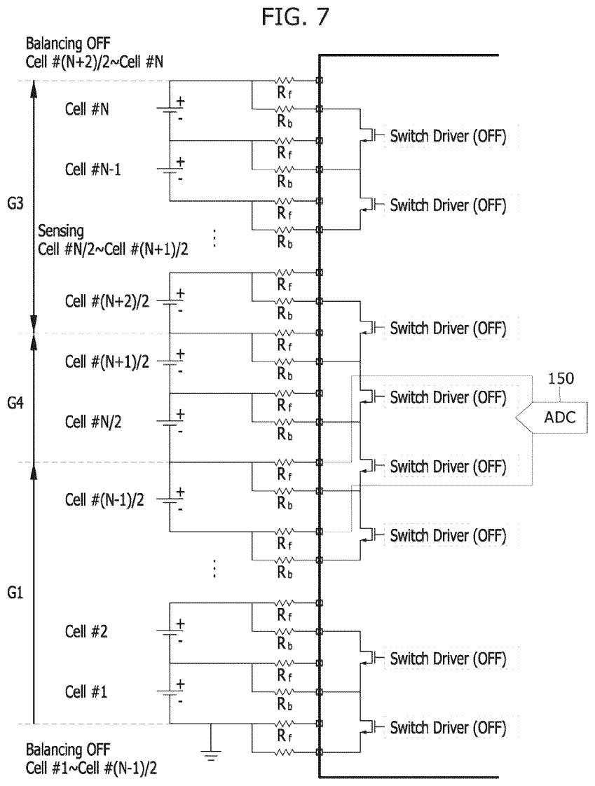

FIG. 7 is an exemplary diagram illustrating sensing and balancing operations in a second period of a battery balancing apparatus according to an embodiment of the present disclosure.

As shown in FIG. 7 together with FIG. 1, when balancing for a second channel G2 is completed, the processor 110 terminates balancing and waits. When voltage sensing for the first channel G1 is completed, the processor 110 stores the measured voltage data in the memory device 120.

In a second period P2, the processor 110 sets the battery cells located at a boundary point between the first channel G1 and the second channel G2 to a third channel G3.

For example, among first to N^{th} battery cells, the processor 110 may set the (N/2)^{th} battery cell and the ((N+1)/2)^{th} battery cell to the third channel. In addition, when there is a battery cell not included in the first channel G1 and the second channel G2, the processor 110 may include the corresponding battery cell in the third channel.

The processor 110 performs voltage sensing for the third channel G3. The processor 110 controls the connection of the ADC 150 to measure the voltage of the battery cells included in the third channel G3.

In this case, the processor 110 restricts the balancing operation from being performed while the voltage sensing for the third channel is performed. Since the battery cells included in the third channel belong to the first channel G1 or the second channel G2 or are located adjacent to the battery cell of each channel, the processor 110 prevents the balancing operation from being performed on another channel so as not to affect the voltage of the battery cells included in the third channel G3.

Accordingly, the processor 110 controls all of the plurality of balancing switches connected to the plurality of battery cells 191 to 199 to be turned off. However, only in the case of a battery cell not adjacent to the battery cell belonging to the third channel G3, the processor 110 performs a balancing operation, as necessary.

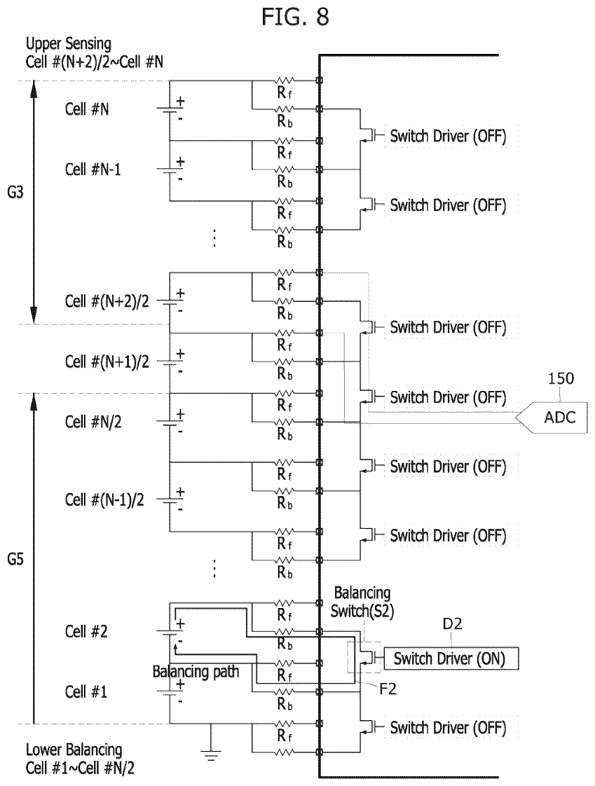

FIG. 8 is an exemplary diagram illustrating sensing and balancing operations in a third period of a battery balancing apparatus according to an embodiment of the present disclosure.

Referring to FIG. 8, when voltage sensing for a third channel G3 is completed, the processor 110 controls balancing to be performed on the first channel G1 and voltage sensing to be performed on a second channel G2 in the third period P3.

In this case, the processor 110 changes the battery cell configurations of the first channel G1 and the second channel G2 to reset the first channel G1 and the second channel G2 to a fourth channel G4 and a fifth channel G5, respectively. For example, the processor 110 may set the first battery cell to the (N/2)^{th} battery cell to the fourth channel, and set the ((N+2)/2)^{th} battery cell to the N^{th} battery cell to the fifth channel. That is, the processor 110 may set the fourth channel G4 and the fifth channel G5 by adding a battery cell at a boundary point included in the third channel G3 to the first channel G1 or the second channel G2 or excluding the battery cell at the boundary point from the first channel G1 or the second channel G2.

The processor 110 performs balancing for the battery cells included in the fourth channel G4 in the third period P3 and performs voltage sensing for the battery cells included in the fifth channel G5.

The processor 110 controls the connection of the ADC 150 to sequentially measure the voltages of the battery cells of the fifth channel G5.

The processor 110 controls the operation of a second balancing switch S2 by applying a control signal to a connected switch driver D2 to the battery cell set as a balancing target among the battery cells included in the fourth channel G4. The processor 110 controls the voltage of the second battery cell that is the balancing target by applying current through a second balancing path F2.

Accordingly, the voltage of the second battery cell included in the first channel G1 and the fourth channel G4 is measured through voltage sensing in the first period P1, and the voltage is controlled through the balancing operation in the third period P3. Additionally, the voltage of the N^{th} battery cell included in the second channel G2 and the fifth channel G5 is controlled through the balancing operation in the first period P1, and the voltage is measured through the voltage sensing in the third period P3.

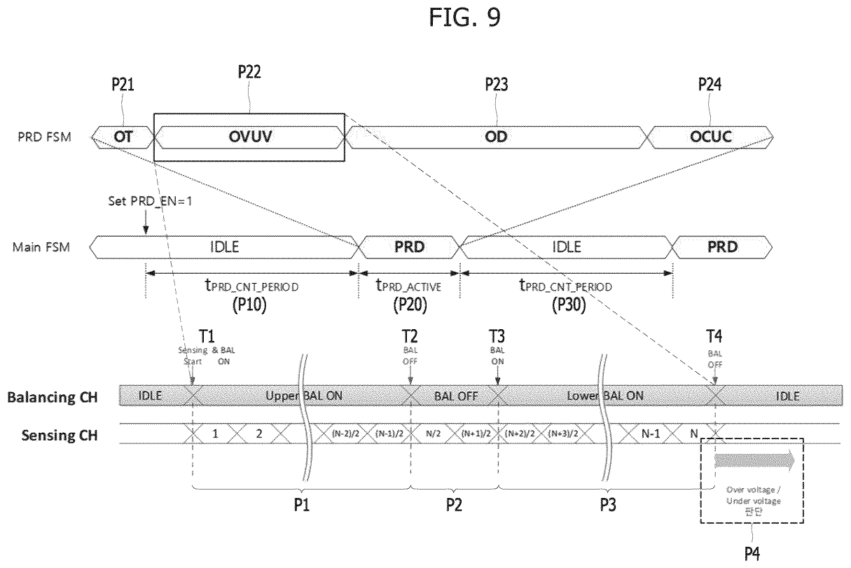

FIG. 9 is a diagram illustrating a diagnostic sequence of a battery balancing apparatus according to an embodiment of the present disclosure.

Referring to FIG. 9, the battery balancing apparatus 100 simultaneously performs voltage sensing and balancing for a plurality of battery cells 191 to 199.

The processor 110 can simultaneously perform voltage sensing and balancing not only in a simultaneous balancing mode, but also in the case of performing diagnosis according to a product requirements document (PRD) P20.

For example, among the diagnostic stages, a temperature over-heat confirmation stage (OT) P21, an over-voltage under-voltage confirmation stage (OVUV) P22, a delay confirmation stage (OD) P23, and an overcurrent under-current confirmation stage (OCUC) P24, the processor 110 may simultaneously perform voltage sensing and balancing for the battery cell in the over-voltage under-voltage confirmation stage (OVUV) P22.

Therefore, according to the battery balancing apparatus and method according to an aspect of the present disclosure, a plurality of battery cells are divided into a plurality of channels, and voltage-sensing and balancing for the battery cells are simultaneously performed for each channel unit. Accordingly, thermal runaway may be prevented by reducing the time required for balancing the battery cells and completing the balancing of the battery cells. In addition, according to the battery balancing apparatus and method according to an aspect of the present disclosure, it is possible to prevent overcharging of battery cells, to reduce a voltage deviation between battery cells, improve battery efficiency, and to extend a life of the battery.

Although exemplary embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. A battery balancing apparatus, comprising:
a battery including a plurality of battery cells; and
a processor configured to:
set the plurality of battery cells to a plurality of channels including a first channel and a second channel; and
perform a balancing operation for the battery cells included in the second channel while sensing voltages of the battery cells included in the first channel.

2. The battery balancing apparatus of claim 1, wherein the processor is further configured to:
set a battery cell with a voltage difference equal to or greater than a certain value from an adjacent battery cell as a balancing target among the battery cells included in the second channel based on a pre-measured voltage; and
perform a balancing operation on the balancing target.

3. The battery balancing apparatus of claim 1, wherein the plurality of channels further includes a third channel, and
wherein, in response to the voltage sensing for the first channel and the balancing operation for the second channel being completed, the processor is further configured to:
set the third channel; and
control voltage sensing for the battery cells included in the third channel.

4. The battery balancing apparatus of claim 3, wherein the processor is further configured to set a battery cell located at a boundary point between the first channel and the second channel to the third channel.

5. The battery balancing apparatus of claim 3, wherein the processor is further configured to control the balancing operation to not be performed in another channel while voltage sensing for the third channel is performed.

6. The battery balancing apparatus of claim 3, wherein the plurality of channels further includes a fourth channel and a fifth channel, and
wherein, in response to the voltage sensing for the third channel being completed, the processor is further configured to:
set the fourth channel and the fifth channel by adding the battery cells included in the third channel to the first and second channels or by excluding the battery cells included in the third channel from the first and second channels;
perform a balancing operation on the battery cells included in the fourth channel; and
sense the voltages of the battery cells included in the fifth channel.

7. A processor-implemented method of balancing a battery, the method comprising:
setting, by a processor, a plurality of battery cells included in a battery to a plurality of channels including a first channel and a second channel;
requesting, by the processor, a voltage sensing operation for the battery cells included in the first channel; and
performing, by the processor, a balancing operation for the battery cells included in the second channel while the voltage sensing operation for the first channel is performed.

8. The method of claim 7, wherein in the performing of the balancing operation, the processor is configured to:
set a battery cell with a voltage difference equal to or greater than a certain value from an adjacent battery cell as a balancing target among the battery cells included in the second channel, based on a pre-measured voltage; and
perform a balancing operation on the balancing target.

9. The method of claim 7, wherein the plurality of channels further includes a third channel, the third channel including a battery cell located at a boundary point between the first channel and the second channel among the plurality of battery cells, and
wherein, in response to the voltage sensing for the first channel and the balancing operation for the second channel being completed, the method further comprises:
controlling, by the processor, voltage sensing for the battery cells included in the third channel; and
controlling, by the processor, the balancing operation to not be performed in another channel while the voltage sensing for the third channel is performed.

10. The method of claim 9, wherein the plurality of channels further includes a fourth channel and a fifth channel, and
wherein the method further comprises:
setting, by the processor, the fourth channel and the fifth channel by adding the battery cells included in the third channel to the first channel and the second channel or by excluding the battery cells included in the third channel from the first channel and the second channel in response to the voltage sensing for the third channel is completed;
performing, by the processor, a balancing operation on the battery cells included in the fourth channel; and
controlling, by the processor, to sense voltages of the battery cells included in the fifth channel during the balancing operation for the fourth channel is performed.
